(19) United States
(12) Patent Application Publication
(10) Pub. No.: US 2013/0177242 A1
(43) Pub. Date: Jul. 11, 2013

(54) SUPER-RESOLUTION IMAGE USING SELECTED EDGE PIXELS

(71) Applicants: James E. Adams, JR., Rochester, NY (US); Mrityunjay Kumar, Rochester, NY (US); Wei Hao, Webster, NY (US)

(72) Inventors: James E. Adams, JR., Rochester, NY (US); Mrityunjay Kumar, Rochester, NY (US); Wei Hao, Webster, NY (US)

(21) Appl. No.: 13/346,816

(22) Filed: Jan. 10, 2012

(51) Int. Cl. G06K 9/00; G06K 9/40; G06K 9/32

(52) U.S. Cl. 382/167; 382/299; 382/260

(57) ABSTRACT

A method of providing a super-resolution image is disclosed. The method uses a processor to perform the following steps of acquiring a captured low-resolution image of a scene and resizing the low-resolution image to provide a high-resolution image. The method further includes computing local edge parameters including local edge orientations and local edge centers of gravity from the high-resolution image, selecting edge pixels in the high-resolution image responsive to the local edge parameters, and modifying the high-resolution image in response to the selected edge pixels to provide a super-resolution image.

### FIELD OF THE INVENTION

The present invention relates to a method for producing a super-resolution image from a low-resolution image of a scene.

### BACKGROUND OF THE INVENTION

It is well-known that to produce a low-resolution image from a high-resolution, the high-resolution is first blurred (low-pass filtered) and then subsampled to a lower resolution. It is frequently desirable to invert this process to produce a high-resolution image from a low-resolution image. However, even if the blurring and subsampling operations used to produce the low-resolution image are completely known, they are generally not invertible in a mathematical sense. The most common approximation to this inversion process is to begin by increasing the resolution of the low-resolution image using bicubic, bilinear, or some other linear interpolation process. The result of the interpolation operation is then sharpened in some standard way, such as with unsharp masking. The main problem with this approach is that the linear interpolation operation cannot restore the high-frequency spatial detail discarded by the original subsampling process. As a result, the sharpening operation can only operate on the spatial frequency detail that survived the original subsampling process. Super-resolution processing attempts to address this liability by added new high-frequency spatial detail that is consistent with the existing low-frequency spatial detail to produce a super-resolution image that, in a visual sense, more closely approximates the original high-resolution image. U.S. Pat. No. 7,215,831 to Altunbasak, et al., is an example of one class of super-resolution methods that take a number of low-resolution images that differ from each other by subpixel shifts and combine them into a single high-resolution image. The problem with this approach is that the multiple versions of the low-resolution image are generally not available unless special efforts are made at the time of image capture. A second problem with this approach is the requirement to store and process several low-resolution images which incurs large demands of computation resources. U.S. Pat. No. 7,218,796 to Bishop, et al., is an example of another class of super-resolution methods that use a dictionary of low-resolution regions and their corresponding high-resolution regions to construct a high-resolution image using a dictionary look up process. The problem with this approach is that the dictionary needs to be large and constructed from an appropriate training set of image in order to produce acceptable quality high-resolution images. If the dictionary has too few entries, there may not be enough variety in the spatial information to produce a good quality high-resolution image. If the low-resolution image is too dissimilar to the images in the training set used to create the dictionary, the quality of the resulting high-resolution image may also be insufficient. The solution of having a large dictionary, however, brings with it the significant problems of storing and searching such a large database of information. U.S. Patent Application Publication No. 2010/0061638 to Tanaka is an example a third class of super-resolution methods that examines each pixel neighborhood within the low-resolution image and produces corresponding high-resolution pixel neighborhoods based on combining only similar pixels within the low-resolution pixel neighborhood to produce the corresponding high-resolution pixel neighborhood. The problem with this approach is that while it uses nonlinear processing to produce results superior to linear interpolation methods, it is still limited to the spatial frequency detail present in the low-resolution image. No new high-frequency detail is added in a true super-resolution manner.

### SUMMARY OF THE INVENTION

In accordance with the present invention there is provided a method of providing a super-resolution image, comprising using a processor to perform the following:

(a) acquiring a captured low-resolution image of a scene;

(b) resizing the low-resolution image to provide a high-resolution image;

(c) computing local edge parameters including local edge orientations and local edge centers of gravity from the high-resolution image;

(d) selecting edge pixels in the high-resolution image responsive to the local edge parameters; and

(e) modifying the high-resolution image in response to the selected edge pixels to provide a super-resolution image.

This invention has the advantage that the super-resolution image is produced without the need of several different captured low-resolution images of the scene or a dictionary of low-resolution to high-resolution image regions that needs to be created, stored, and searched. As a result, the computational requirements of the present invention are significantly reduced and the processing time considerably shortened over the prior art.

It has the additional advantage of being able to produce super-resolution improvement for multiple spatial frequencies throughout the spatial frequency spectrum without substantial increase in computation resources or processing time.

This and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3 is a block diagram of the preferred embodiment of the present invention;

FIG. 4 is a block diagram showing a detailed view of the super-resolution sharpening block for a preferred embodiment of the present invention;

FIG. 5 is a block diagram showing a detailed view of the sharpen luminance block for a preferred embodiment of the present invention;

FIG. 6 is a block diagram showing a detailed view of the sharpen high-pass image block for a preferred embodiment of the present invention;

FIG. 7 is a block diagram showing a detailed view of the adaptive sharpening block for a preferred embodiment of the present invention;

FIG. 8 is a block diagram showing a detailed view of the sharpen edge pixels block for a preferred embodiment of the present invention;

FIG. 9 is a block diagram showing a detailed view of the adjust sharpness gain block for an alternate embodiment of the present invention;

FIG. 10 is a diagram of a support region used in a preferred embodiment of the present invention;

FIG. 11 is a block diagram of an alternate embodiment of the present invention;

FIG. 12 is a block diagram of an alternate embodiment of the present invention; and

FIG. 13 is a block diagram of an alternate embodiment of the present invention.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of a digital camera will be familiar to one skilled in the art. It will be obvious that there are many variations of this embodiment that are possible and are selected to reduce the cost, add features or improve the performance of the camera.

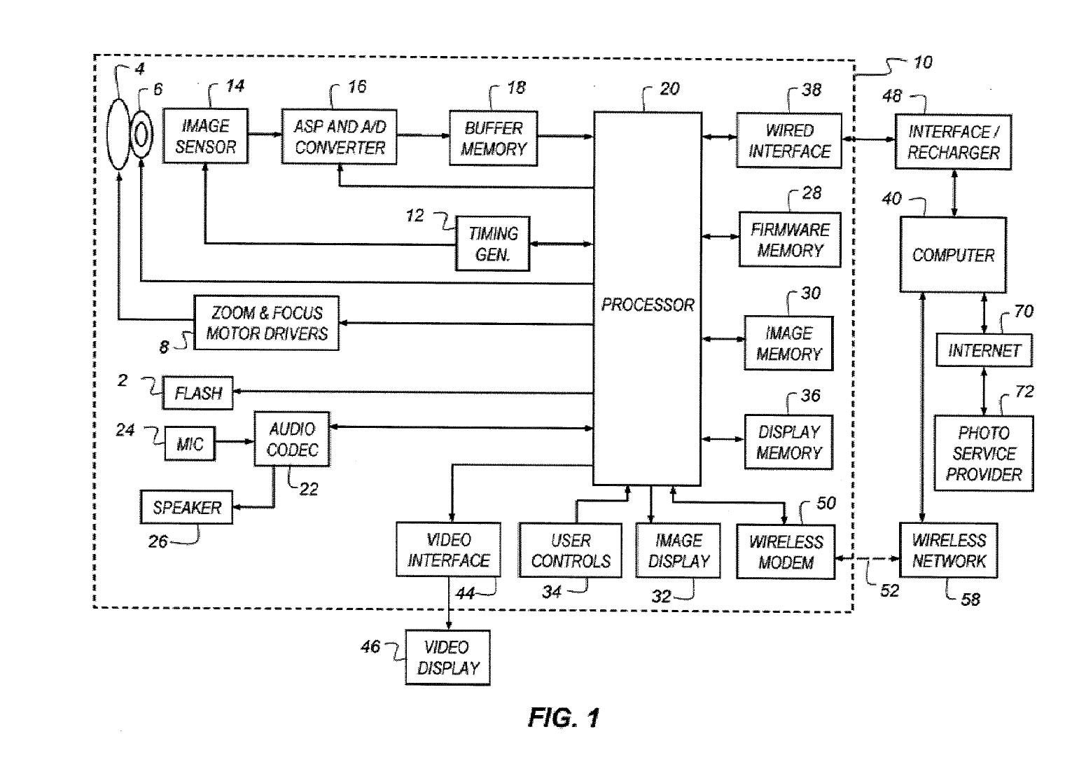

FIG. 1 depicts a block diagram of a digital photography system, including a digital camera 10 in accordance with the present invention. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drives 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system can use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using a wired interface 38 or a wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by the timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor 14 is generally overlaid with a color filter array, which provides an image sensor 14 having an array of pixels that include different colored pixels. The different color pixels can be arranged in many different patterns. As one example, the different color pixels can be arranged using the well-known Bayer color filter array, as described in commonly assigned U.S. Pat. No. 3,971,065 to Bayer, the disclosure of which is incorporated herein by reference. As a second example, the different color pixels can be arranged as described in commonly assigned U.S. Patent Application Publication 2007/0024931 to Compton and Hamilton, the disclosure of which is incorporated herein by reference. These examples are not limiting, and many other color patterns can be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly columns and rows of data, compared to the resolution of the image sensor 14.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of an adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene.

The lens 4 of the digital camera 10 can be focused in the first mode by using “through-the-lens” autofocus, as described in commonly-assigned U.S. Pat. No. 5,668,597 to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance which corresponds to the closest focus position can then be utilized for several purposes, such as automatically setting an appropriate scene mode, and can be stored as metadata in the image file, along with other lens and camera settings.

The processor 20 produces menus and low resolution color images that are temporarily stored in a display memory 36 and are displayed on an image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 is controlled in response to user input provided by user controls 34. The user controls 34 are used to select various camera modes, such as video capture mode, still capture mode, and review mode, and to initiate capture of still images, recording of motion images. The user controls 34 are also used to set user processing preferences, and to choose between various photography modes based on scene type and taking conditions. In some embodiments, various camera settings can be set automatically in response to analysis of preview image data, audio signals, or external signals such as GPS, weather broadcasts, or other available signals.

In some embodiments, when the digital camera 10 is in a still photography mode the above-described preview mode is initiated when the user partially depresses a shutter button, which is one of the user controls 34, and the still image capture mode is initiated when the user fully depresses the shutter button. The user controls 34 are also used to turn on the digital camera 10, control the lens 4, and initiate the picture taking process. User controls 34 typically include some combination of buttons, rocker switches, joysticks, or rotary dials. In some embodiments, some of the user controls 34 are provided by using a touch screen overlay on the image display 32. In other embodiments, the user controls 34 can include a way to receive input from the user or an external device via a tethered, wireless, voice activated, visual or other interface. In other embodiments, additional status displays or images displays can be used.

The camera modes that can be selected using the user controls 34 include a “timer” mode. When the “timer” mode is selected, a short delay (e.g., 10 seconds) occurs after the user fully presses the shutter button, before the processor 20 initiates the capture of a still image.

An audio codec 22 connected to the processor 20 receives an audio signal from a microphone 24 and provides an audio signal to a speaker 26. These components can be used to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control 34 has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include the wireless modem 50, which interfaces over a radio frequency band 52 with a wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

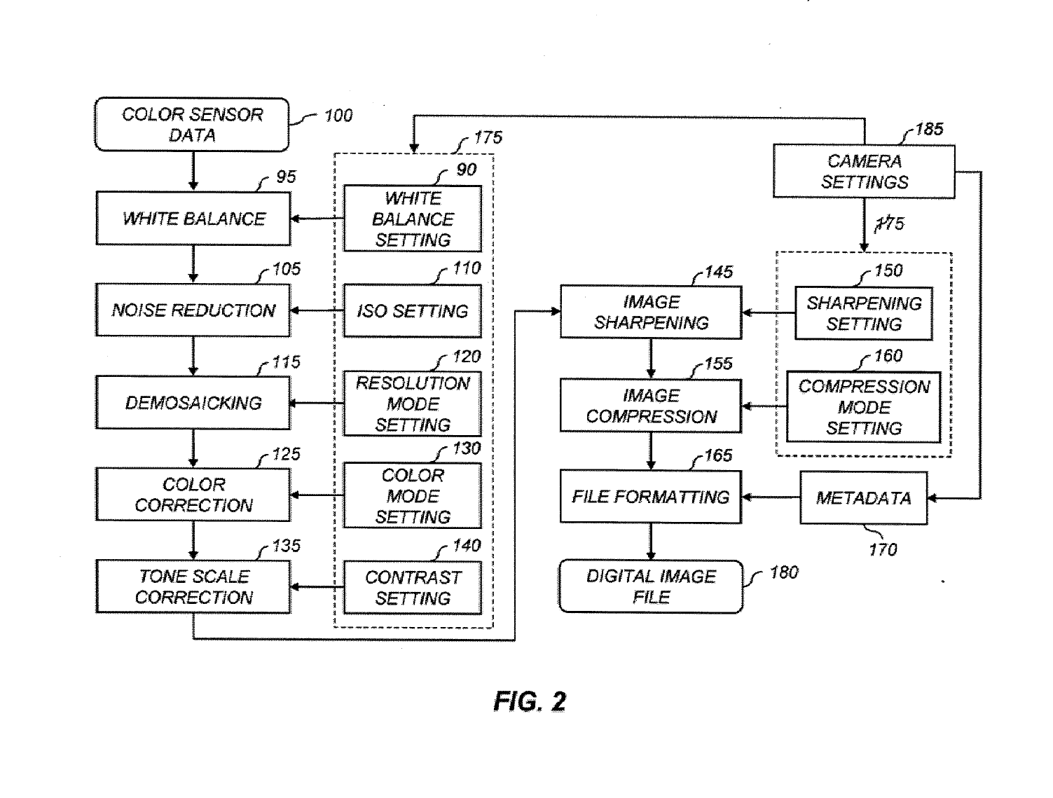

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various photography mode settings 175, which are typically associated with photography modes that can be selected via the user controls 34, which enable the user to adjust various camera settings 185 in response to menus displayed on the image display 32.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, the disclosure of which is herein incorporated by reference. The white balance can be adjusted in response to a white balance setting 90, which can be manually set by a user, or which can be automatically set by the digital camera 10.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al, the disclosure of which is herein incorporated by reference. The level of noise reduction can be adjusted in response to an ISO setting 110, so that more filtering is performed at higher ISO exposure index setting.

The color image data is then manipulated by a demosaicking step 115, in order to provide red, green and blue (RGB) image data values at each pixel location. Algorithms for performing the demosaicking step 115 are commonly known as color filter array (CFA) interpolation algorithms or “deBayering” algorithms. In one embodiment of the present invention, the demosaicking step 115 can use the luminance CFA interpolation method described in commonly-assigned U.S. Pat. No. 5,652,621 to Adams et al., the disclosure of which is incorporated herein by reference. The demosaicking step 115 can also use the chrominance CFA interpolation method described in commonly-assigned U.S. Pat. No. 4,642,678 to Cok, the disclosure of which is herein incorporated by reference.

In some embodiments, the user can select between different pixel resolution modes, so that the digital camera 10 can produce a smaller size image file. Multiple pixel resolutions can be provided as described in commonly-assigned U.S. Pat. No. 5,493,335 to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511 to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

### Setting 1 (Normal Color Reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

### Setting 2 (Saturated Color Reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

### Setting 3 (De-Saturated Color Reproduction)

$$[ \begin{matrix}{R}_{out} \\ {G}_{out} \\ {B}_{out}\end{matrix} ] [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

### Setting 4 (Monochrome)

$$[ \begin{matrix}{R}_{out} \\ {G}_{out} \\ {B}_{out}\end{matrix} ] [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574 to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in the digital image file 180 using a file formatting step 165. The digital image file 180 can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about various camera settings 185, including the photography mode settings 175.

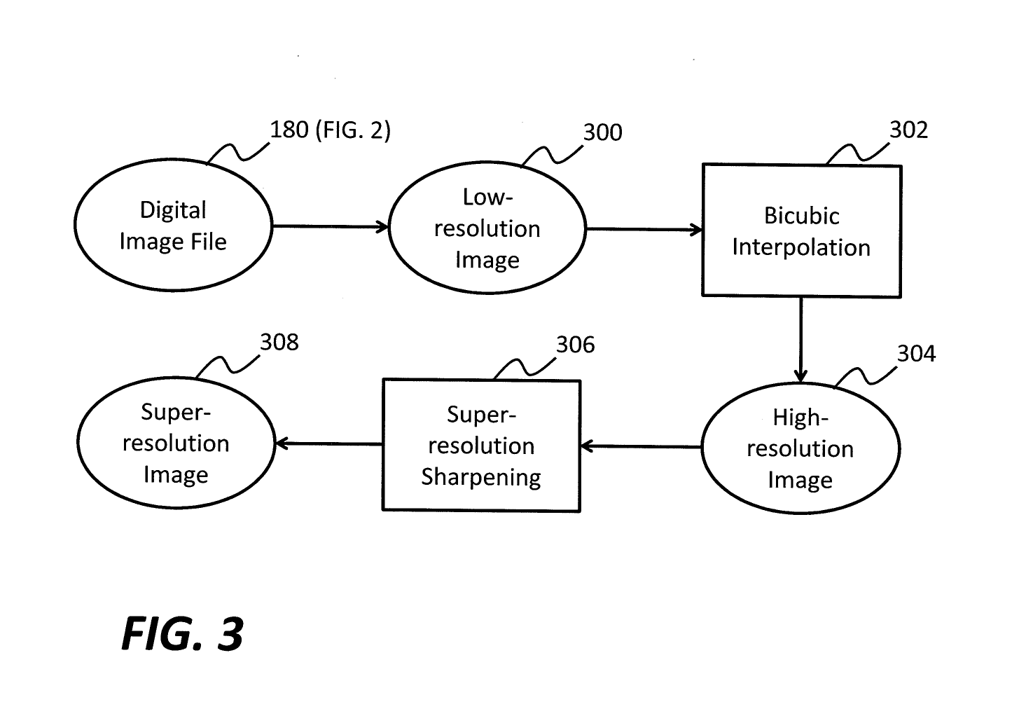

The present invention will now be described with reference to FIG. 3. FIG. 3 is a flowchart of a top view of the preferred embodiment. A bicubic interpolation block 302 produces a high-resolution image 304 from a low-resolution image 300 which is read from the digital image file 180 (FIG. 2). The bicubic interpolation block 302 is a standard operation well-known to those skilled in the art. In an alternate embodiment of the present invention bilinear interpolation is used in place of bicubic interpolation. A super-resolution sharpening block 306, to be described below, produces a super-resolution image 308 from the high-resolution image 304.

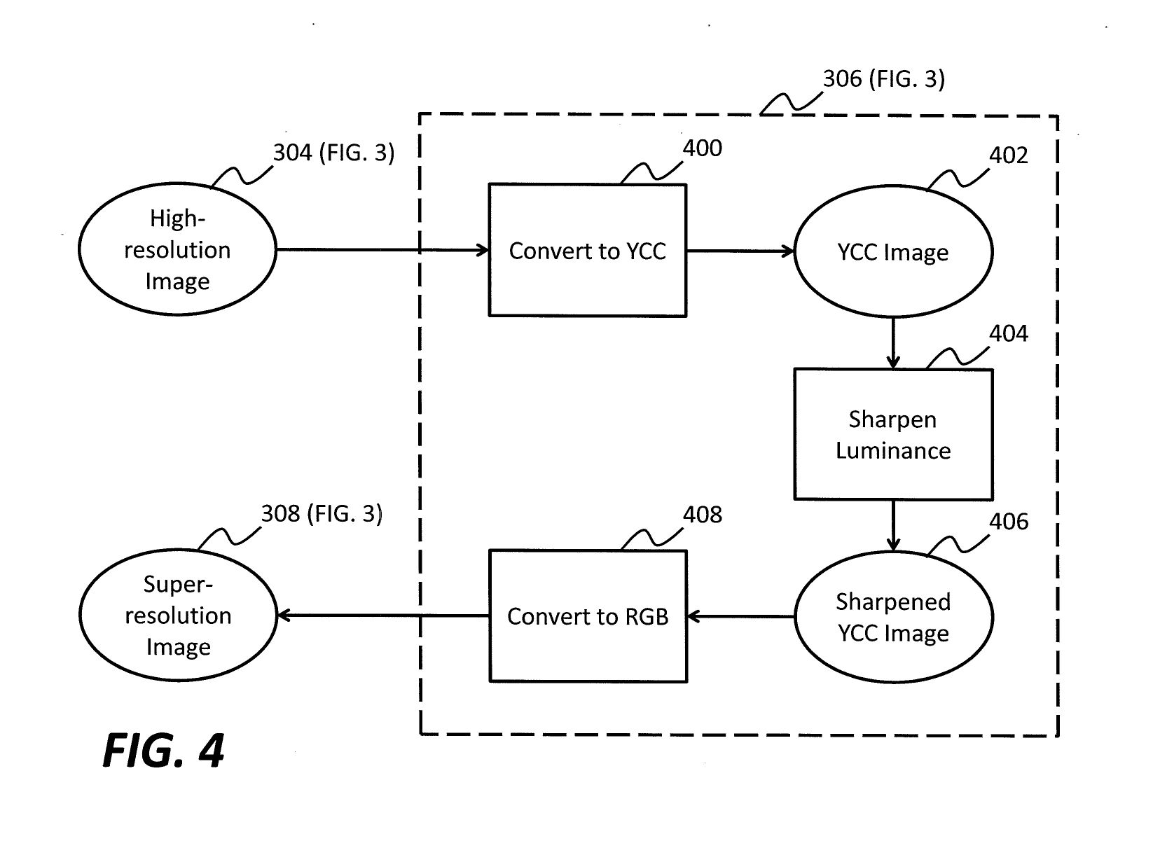

FIG. 4 is a detailed description of the super-resolution sharpening block 306 (FIG. 3) for the preferred embodiment. A convert to YCC block 400 produces a YCC image 402 from the high-resolution image 304 (FIG. 3). The convert to YCC block 400 uses the following transform create luminance (Y) and chrominance (C₁ and C₂) pixel values from red (R), green (G), and blue (B) pixel values.

$$( \begin{matrix}Y \\ {C}_{1} \\ {C}_{2}\end{matrix} ) = \frac{1}{4} ( \begin{matrix}1 & 2 & 1 \\ - 1 & 2 & - 1 \\ 2 & 0 & - 2\end{matrix} ) ( \begin{matrix}R \\ G \\ B\end{matrix} )$$

A sharpen luminance block 404, to be described below, produces a sharpened YCC image 406 from the YCC image 402. A convert to RGB block 408 produces the super-resolution image 308 (FIG. 3) from the sharpened YCC image 406. The following transform is used by the convert to RGB block 408 to produce RGB pixel values from YCC pixel values.

$$( \begin{matrix}R \\ G \\ B\end{matrix} ) = ( \begin{matrix}1 & - 1 & - 1 \\ 1 & 1 & 0 \\ 1 & - 1 & 1\end{matrix} ) ( \begin{matrix}Y \\ {C}_{1} \\ {C}_{2}\end{matrix} )$$

It will be apparent to those skilled in the art that other transforms can be used to convert to YCC and to convert to RGB.

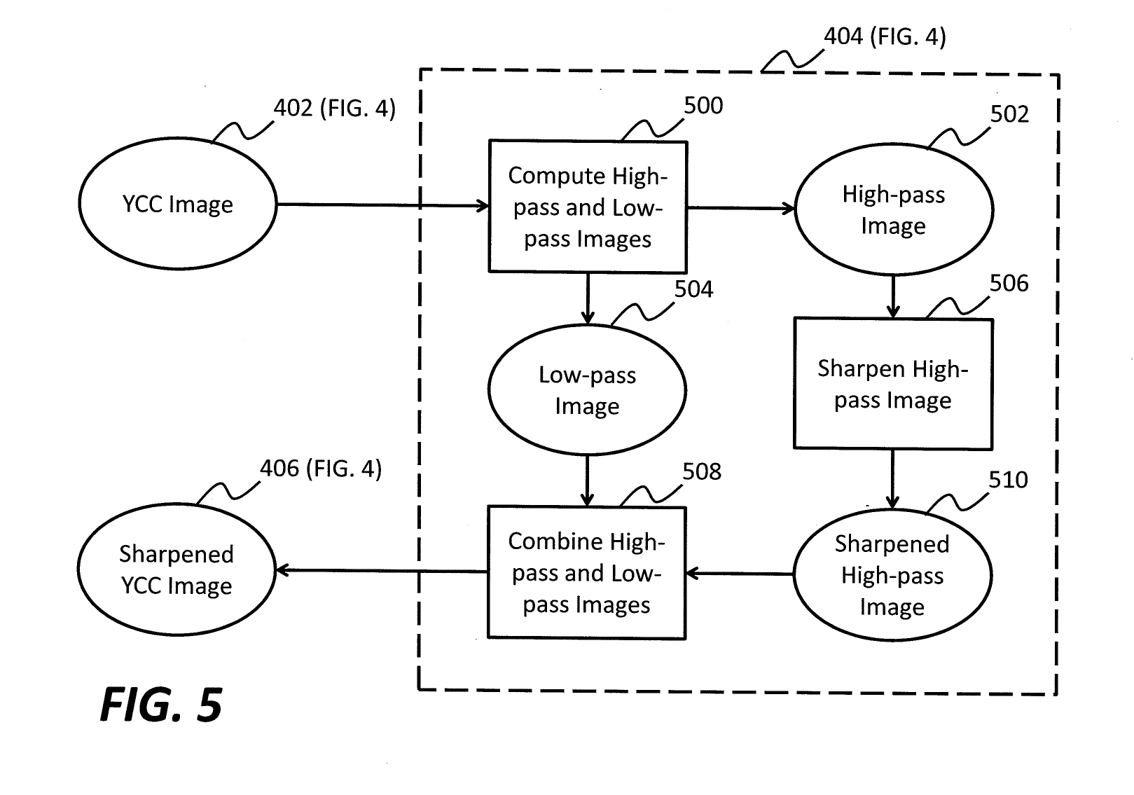

FIG. 5 is a detailed description of the sharpen luminance block 404 (FIG. 4) for the preferred embodiment. A compute high-pass and low-pass images block 500 produces a low-pass image 504 and a high-pass image 502 from the YCC image 402 (FIG. 4). The compute high-pass and low-pass images block 500 convolves the following high-pass filter (h) with the luminance channel of the YCC image 402 (FIG. 4) to produce the high-pass image 502.

$$h = \frac{1}{374} ( \begin{matrix}- 1 & - 3 & - 4 & - 4 & - 4 & - 3 & - 1 \\ - 3 & 3 & 3 & 4 & 3 & 3 & - 3 \\ - 4 & 3 & 2 & 3 & 2 & 3 & - 4 \\ - 4 & 4 & 3 & 4 & 3 & 4 & - 4 \\ - 4 & 3 & 2 & 3 & 2 & 3 & - 4 \\ - 3 & 3 & 3 & 4 & 3 & 3 & - 3 \\ - 1 & - 3 & - 4 & - 4 & - 4 & - 3 & - 1\end{matrix} )$$

The high-pass filter is the convolution of a 5×5 low-pass filter and a 3×3 high-pass filter. It will be apparent to those skilled in the art how to construct similar high-pass filters. The high-pass image 502 is subtracted from the luminance channel of the YCC image 402 (FIG. 4) to produce the low-pass image 504. A sharpen high-pass image block 506, to be described below, produces a sharpened high-pass image 510 from the high-pass image 502. A combine high-pass and low-pass images block 508 adds the sharpened high-pass image 510 and the low-pass image 504 to produce the sharpened YCC image 406 (FIG. 4).

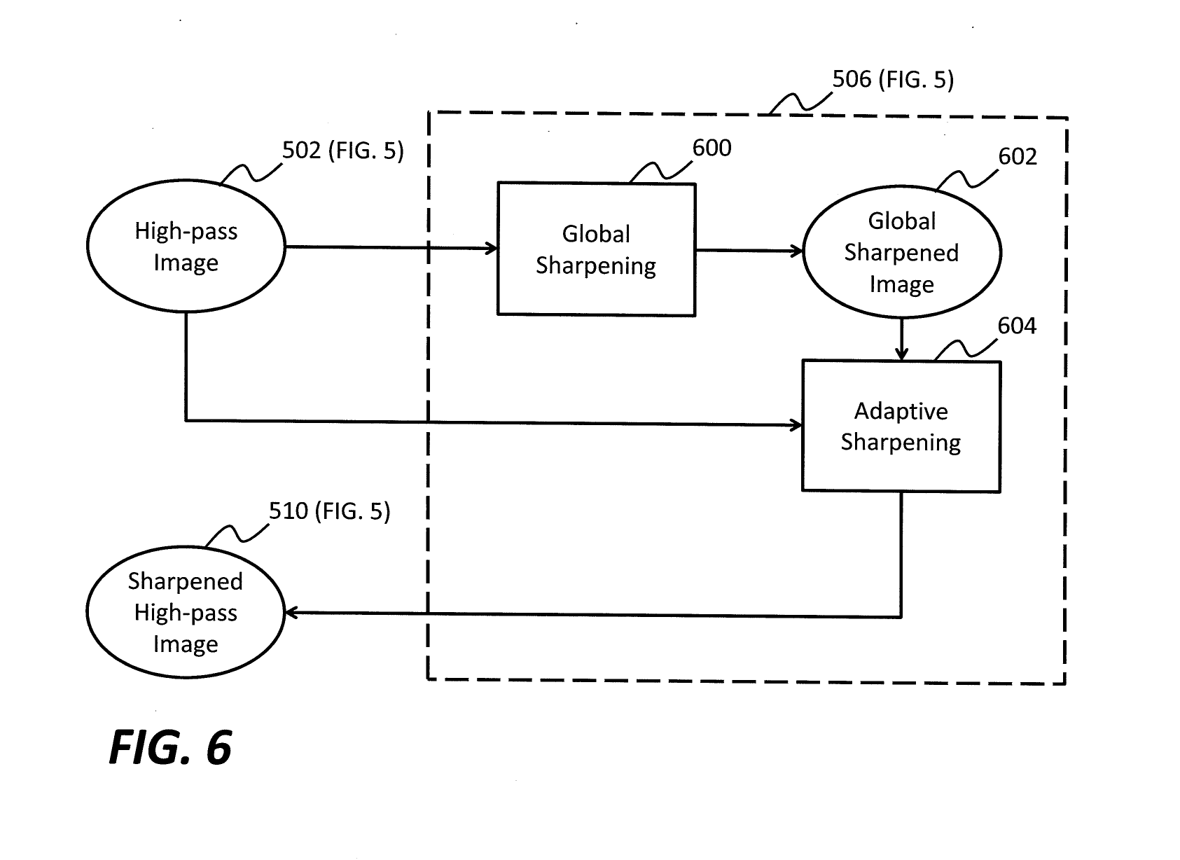

FIG. 6 is a detailed description of the sharpen high-pass image block 506 (FIG. 5) for the preferred embodiment. A global sharpening block 600 produces a global sharpened image 602 by scaling (multiplying) the high-pass image 502 (FIG. 5) by a global sharpening scaling constant. If y_{H} is the high-pass image 502 (FIG. 5), γ_{G} is the global sharpening scaling constant, and y_{HG} is the global sharpened image 602, then γ_{HG}=γ_{G} y_{H}. A typical value for γ_{G} is 1.25. An adaptive sharpening block 604, to be described below, produces the sharpened high-pass image 510 (FIG. 5) from the high-pass image 502 (FIG. 5) and the global sharpened image 602.

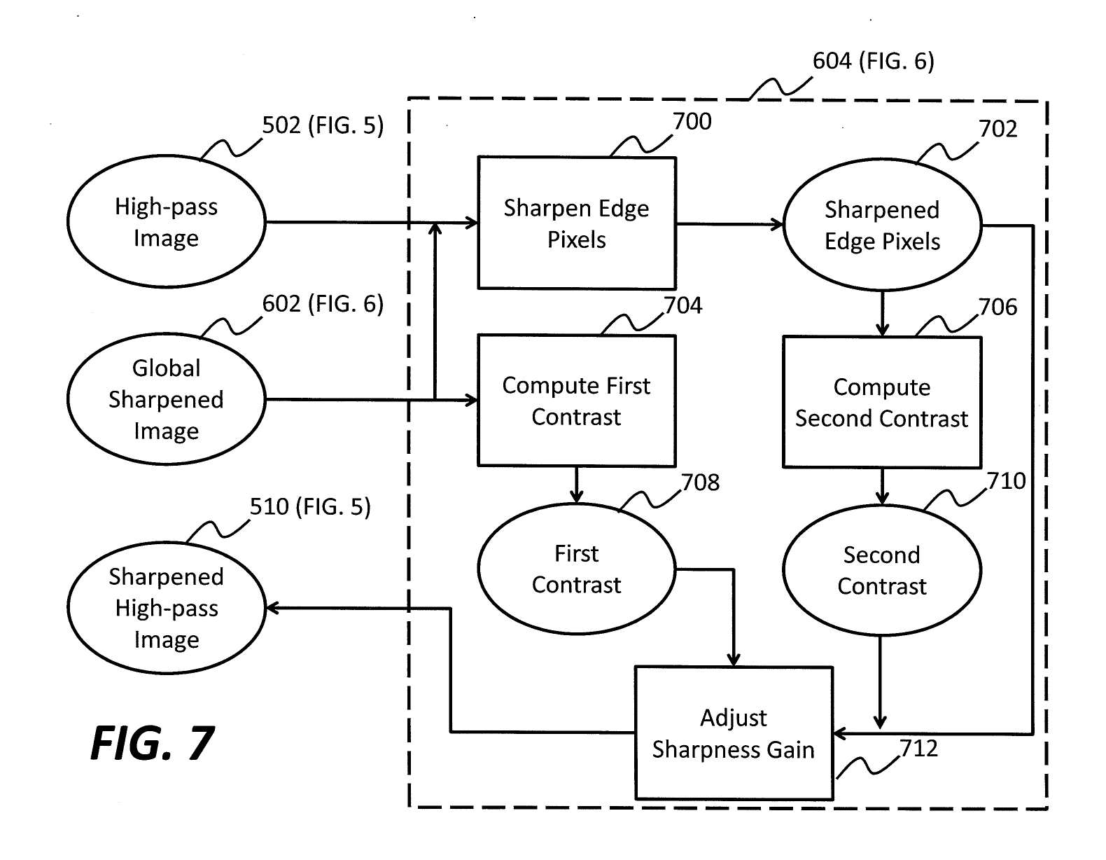

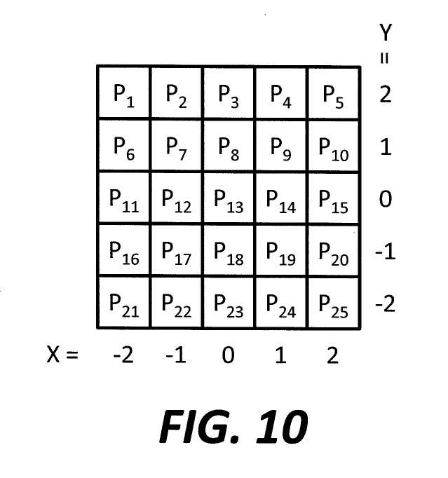

FIG. 7 is a detailed description of the adaptive sharpening block 604 (FIG. 6) for the preferred embodiment. A sharpen edge pixels block 700, to be described below, produces sharpened edge pixels 702 from the high-pass image 502 (FIG. 5) and the global sharpened image 602 (FIG. 6). A compute first contrast block 704 produces a first contrast 708 from the global sharpened image 602 (FIG. 6). The compute first contrast block 704 defines a support region as shown in FIG. 10 for each pixel location within the global sharpened image 602 (FIG. 6). In FIG. 10 the first contrast 708 for P₁₃ is computed by finding the maximum global sharpened image 602 (FIG. 6) pixel value and the minimum global sharpened image 602 (FIG. 6) pixel value for all the pixel values, P₁ through P₂₅, within the support region. If y_{HGmax} is the maximum global sharpened image 602 (FIG. 6) pixel value and y_{HGmin} is the minimum global sharpened image 602 (FIG. 6) pixel value, then the first contrast 708 c₁ is (y_{HGmax}−y_{HGmin})/(y_{HGmax}+y_{HGmin}). A compute second contrast block 706 produces a second contrast 710 from the sharpened edge pixels 702. The compute second contrast block 706 performs a similar computation to the compute first contrast block 704, using a support region as shown in FIG. 10. If y_{HA} is the sharpened edge pixels 702, then y_{HAmax} is the maximum sharpened edge pixels 702 pixel value and y_{HAmin} is the minimum sharpened edge pixels 702 pixel value. The second contrast 710 c₂ is (y_{HAmax}−y_{HAmin})/(y_{HAmax}+y_{HAmin}). An adjust sharpness gain block 712, to be described below, produces the sharpened high-pass image 510 (FIG. 5) from the first contrast 708, the second contrast 710, and the sharpened edge pixels 702.

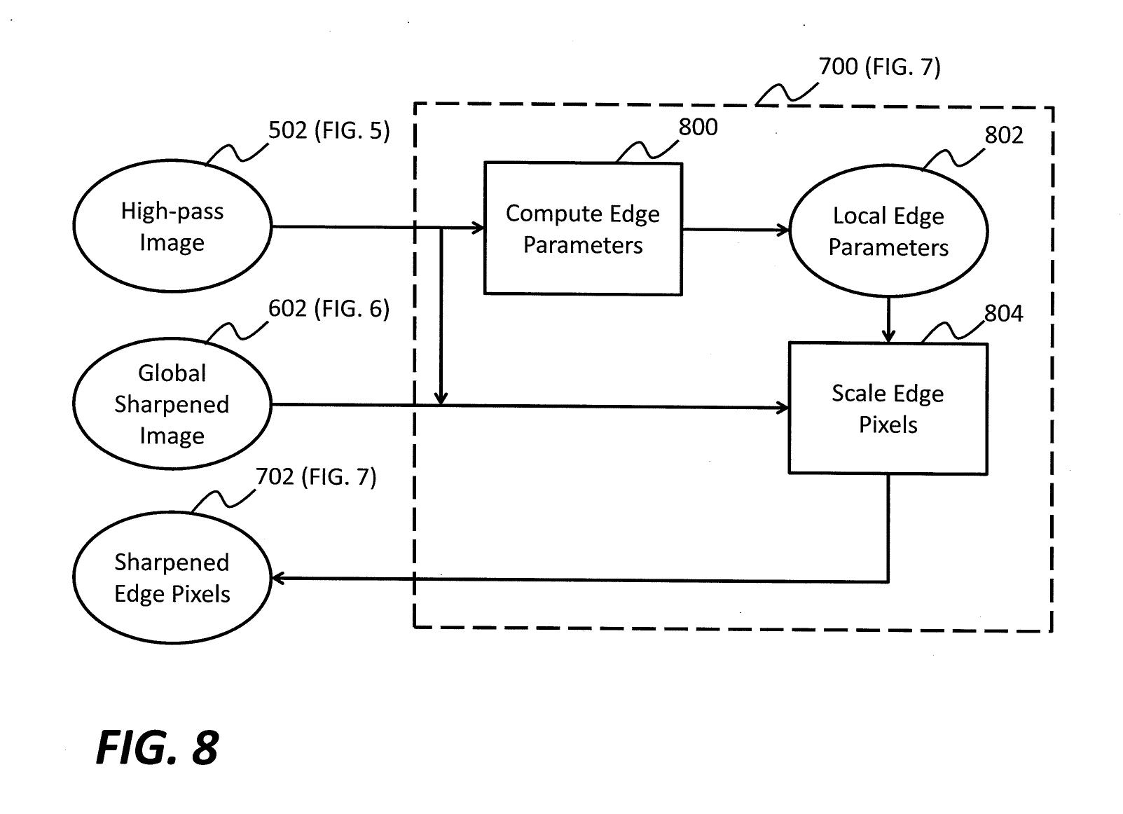

FIG. 8 is a detailed description of the sharpen edge pixels block 700 (FIG. 7) for the preferred embodiment. A compute edge parameters block 800 produces local edge parameters 802 from the high-pass image 502 (FIG. 5). The compute edge parameters block 800 defines a support region, as depicted in FIG. 10, around each pixel in the high-pass image 502 (FIG. 5). Using the values within the support region, a horizontal edge value, u, and a vertical edge value, v, are computed as follows.

u=+P₂+P₆+P₇+P₁₁+P₁₂+P₁₆+P₁₇+P₂₁+P₂₂−P₄−P₅−P₉−P₁₀−P₁₄−P₁₅−P₁₉−P₂₀−P₂₄−P₂₅

v=P₁+P₂+P₃+P₄+P₅+P₆+P₇+P₈+P₉+P₁₀−P₁₆−P₁₇−P₁₈−P₁₉−P₂₀−P₂₁−P₂₂−P₂₃−P₂₄−P₂₅

The magnitude of the edge for the support region, r, is \sqrt{u²+v²}. The orientation or angle of the edge for the support region, θ, is the value that produces the maximum value of u sin θ+v cos θ. In the preferred embodiment, the possible values of θ are restricted to 0, π/4, π/2, 3π/4, π, 5π/4, 3π/2, and 7π/4. Finally, the center of gravity values, x_{c} and y_{c} are computed for the support region.

$${x}_{c} = - 2 ( {P}_{1} + {P}_{6} + {P}_{11} + {P}_{16} + {P}_{21} ) - ( {P}_{2} + {P}_{7} + {P}_{12} + {P}_{17} + {P}_{22} ) + ( {P}_{4} + {P}_{9} + {P}_{14} + {P}_{19} + {P}_{24} ) + 2 ( {P}_{5} + {P}_{10} + {P}_{15} + {P}_{20} + {P}_{25} )$$

$${y}_{c} = - 2 ( {P}_{21} + {P}_{22} + {P}_{23} + {P}_{24} + {P}_{25} ) - ( {P}_{16} + {P}_{17} + {P}_{18} + {P}_{19} + {P}_{20} ) + ( {P}_{6} + {P}_{7} + {P}_{8} + {P}_{9} + {P}_{10} ) + 2 ( {P}_{1} + {P}_{2} + {P}_{3} + {P}_{4} + {P}_{5} )$$

The magnitude of the edge, r, the orientation or angle of the edge, θ, and the center of gravity values, x_{c} and y_{c}, taken together of the local edge parameters 802 for a given pixel location within the high-pass image 502 (FIG. 5). A scale edge pixels block 804 produces the sharpened edge pixels 702 (FIG. 7) from the local edge parameters 802, the high-pass image 502 (FIG. 5), and the global sharpened image 602 (FIG. 6). For each pixel location in the global sharpened image 602 (FIG. 6) a support region as shown in FIG. 10 is defined around the pixel location P₁₃. If the value of the magnitude of the edge, r, associated with P₁₃ is less than an edge threshold value, t, then the global sharpened image 602 (FIG. 6) pixel values are left unchanged for the support region. A typical value for t is 25. If the value of the magnitude of the edge, r, associated with P₁₃ is greater than or equal to the edge threshold value, t, then five pixels in the support region of the global sharpened image 602 (FIG. 6) are replaced with corresponding high-pass image 502 (FIG. 5) pixel values scaled (multiplied) by an adaptive scaling constant, γ_{A}. A typical value of γ_{A} is 6. The five pixels to be scaled are selected based on the orientation or angle of the edge, θ, and the center of gravity values, x_{c} and y_{c} for the support region. Referring to FIG. 10, if θ=0 or 0=π, a horizontal row of pixel values with y=y_{c} is scaled by γ_{A}. For example, if y_{c}=1, then pixel values P₆, P₇, P₈, P₉, and P₁₀ will be scaled by γ_{A}. If θ=7π/2 or θ=3π/2, then a vertical column of pixel values with x=x_{c} is scaled by γ_{A}. For example, if x_{c}=−1, then pixel values P₂, P₇, P₁₂, P₁₇, and P₂₂ will be scaled by γ_{A}. If θ=7π/4 or θ=5π/4, then a “slash” diagonal of pixel values with x=x_{c} is scaled by γ_{A}. For example, if x_{c}=1, then pixel values P*₁, P₂₂, P₁₈, P₁₄, and P₁₀ will be scaled by γ_{A}. Note that the value of P*₁ refers to the value P₁ from a support adjacent to the bottom edge of the support region shown in FIG. 10. Finally, if θ=3π/4 or θ=7π/4, then a “backslash” diagonal of pixel values with x=x_{c} is scaled by γ_{A}. For example, if x_{c}=1, then pixel values P₂, P₈, P₁₄, P₂₀, and P*₂₁ will be scaled by γ_{A}. Note that the value of P*₂₁ refers to the value P₂₁ from a support adjacent to the right edge of the support region shown in FIG. 10. All scaled pixels overwrite the corresponding pixel values in the global sharpened image 602 (FIG. 6) with the fully modified global sharpened image 602 (FIG. 6) becoming the sharpened edge pixels 702 (FIG. 7).

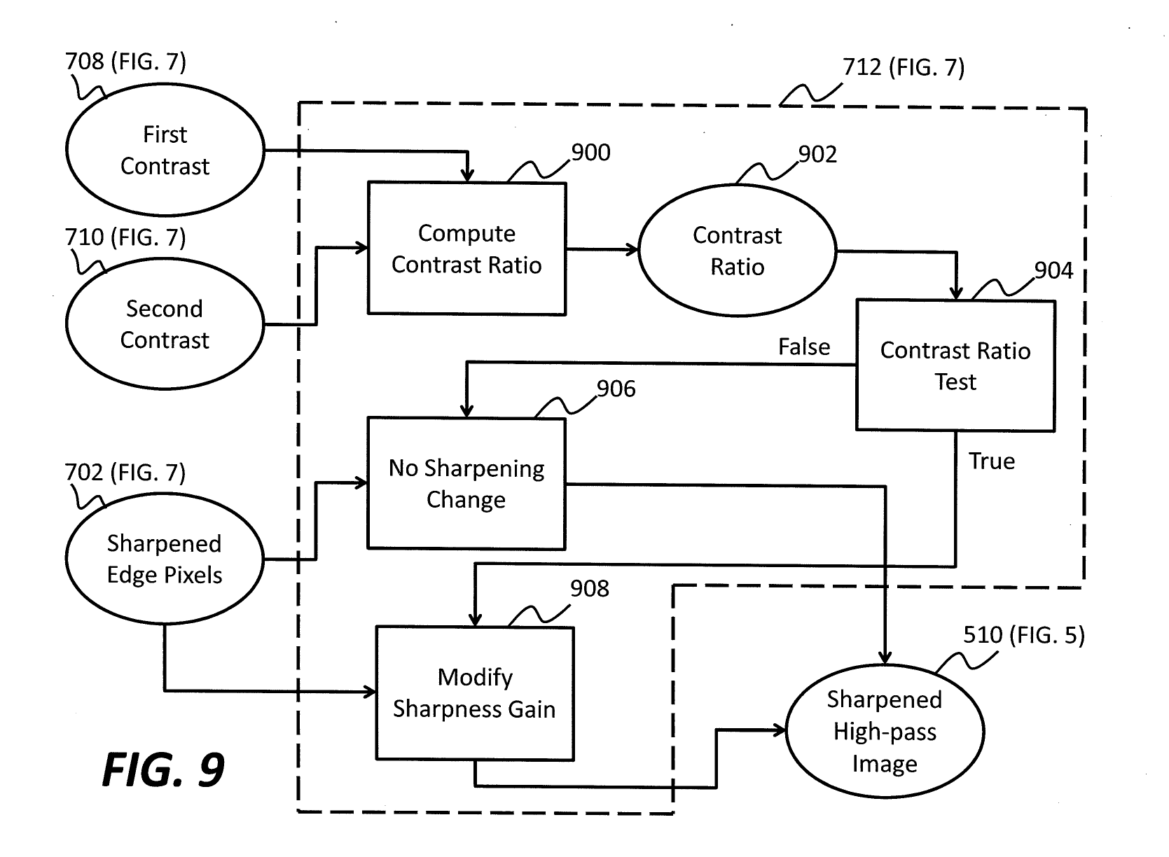

FIG. 9 is a detailed description of the adjust sharpness gain block 712 (FIG. 7) for the preferred embodiment. A compute contrast ratio block 900 produces a contrast ratio 902 from the first contrast 708 (FIG. 7) and the second contrast 710 (FIG. 7). The contrast ratio 902 c_{R} is computed to be c₂/c₁ by the compute contrast ratio block 900. A contrast ratio test block 904 tests to see if the contrast ratio 902 is greater than a contrast limit, c_{L}, “True” in FIG. 9, or if it is less than or equal to the contrast limit, “False” in FIG. 9. A typical value for c_{L}, is 2. In the case of a “False” result from the contrast ratio test block 904, a no sharpening change block 906 pass the sharpened edge pixels 702 (FIG. 7) unaltered to the sharpened high-pass image 510 (FIG. 5). In the case of a “True” result from the contrast ratio test block 904, a modify sharpness gain block 908 recomputes the sharpened edge pixels 702 (FIG. 7) in the manner of the scale edge pixels block 804 (FIG. 8) with a modified adaptive scaling constant of γ_{A}/2, i.e., half of the adaptive scaling constant γ_{A}. A typical value of the modified adaptive scaling constant is 3. The resulting recomputed sharpened edge pixels are passed to the sharpened high-pass image 510 (FIG. 5).

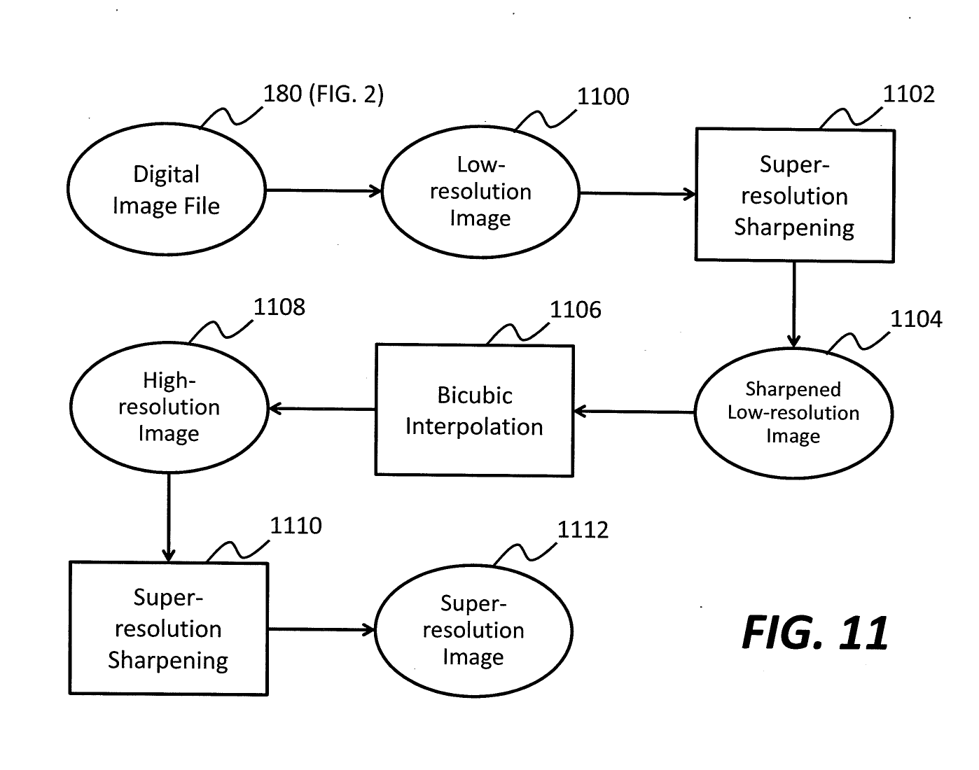

FIG. 11 is a flowchart of a top view of an alternate embodiment of the present invention. A super-resolution sharpening block 1102 produces a sharpened low-resolution image 1104 from a low-resolution image 1100 which is read from the digital image file 180 (FIG. 2). The details of the super-resolution sharpening block 1102 are the same as for the super-resolution sharpening block 306 (FIG. 3) except that the values of γ_{G} and γ_{A} are one-half the size for the super-resolution sharpening block 1102 than used in the super-resolution sharpening block 306 (FIG. 3). A bicubic interpolation block 1106 produces a high-resolution image 1108 from the sharpened low-resolution image 1104. The bicubic interpolation block is, again, a standard operation well-known to those skilled in the art. A super-resolution sharpening block 1110 produces a super-resolution image 1112 from the high-resolution image 1108. The details of the super-resolution sharpening block 1110 are the same as for the super-resolution sharpening block 306 (FIG. 3) including using the same values for γ_{G} and γ_{A}. This alternate embodiment can be viewed as a two-layer pyramid process with super-resolution sharpening occurring at two different image resolutions.

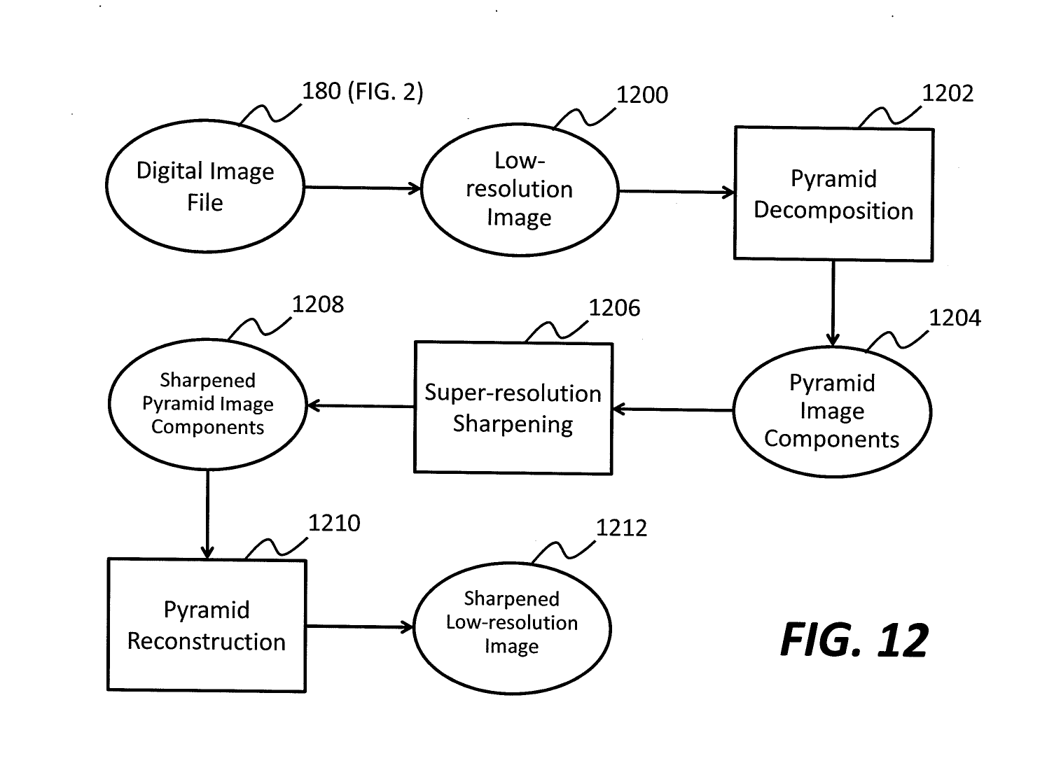

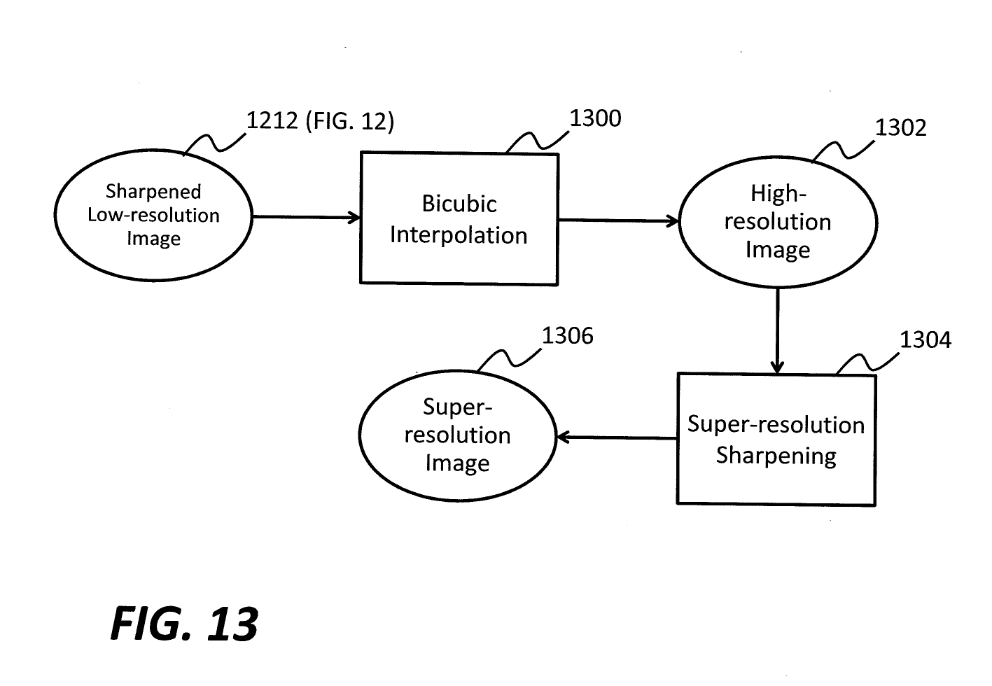

FIG. 12 and FIG. 13 are flowcharts of a top view of another alternate embodiment of the present invention. In FIG. 12, a pyramid decomposition block 1202 produces pyramid image components 1204 from a low-resolution image 1200 which is read from the digital image file 180 (FIG. 2). The pyramid decomposition block 1202 performs a Laplacian-Gaussian pyramid decomposition that is well-known to those skilled in the art. In an alternate embodiment the pyramid decomposition block 1202 performs a wavelet decomposition, also well-known to those skilled in the art. A super-resolution sharpening block 1206 produces sharpened pyramid image components 1208 from the pyramid image components 1204. The super-resolution sharpening block 1206 performs super-resolution sharpening on each pyramid component in the manner of super-resolution sharpening block 1102 (FIG. 11) and super-resolution sharpening block 1110 (FIG. 11), with values of γ_{G} and γ_{A} chosen appropriately for each pyramid level of the pyramid image components 1204. For example, for a four-level pyramid, the values of γ_{G} would be γ_{G}/8, γ_{G}/4, γ_{G}/2, and γ_{G}, from lowest resolution to highest resolution, with γ_{G}=0.625. The corresponding values of γ_{A} would be γ_{A}/8, γ_{A}/4, γ_{A}/2, and γ_{A}, from lowest resolution to highest resolution, with γ_{A}=3. A pyramid reconstruction block 1210 produces a sharpened low-resolution image 1212 from the sharpened pyramid image components 1208. The pyramid reconstruction block 1210 performed the inverse operations of the pyramid decomposition block 1202 and is well-known to those skilled in the art. Turning to FIG. 13, a bicubic interpolation block 1300 produces a high-resolution image 1302 from the sharpened low-resolution image 1212 (FIG. 12). The bicubic interpolation block is, again, a standard operation well-known to those skilled in the art. A super-resolution sharpening block 1304 produces a super-resolution image 1306 from the high-resolution image 1302. The super-resolution sharpening block 1304 performs the same operations as the super-resolution sharpening block 306 (FIG. 3).

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
36 display memory
38 wired interface
40 computer
44 video interface
46 video display
48 interface/recharger
50 wireless modem
52 radio frequency band
58 wireless network
70 Internet
72 photo service provider

### PARTS LIST CONT'D

90 white balance setting
95 white balance step
100 color sensor data
105 noise reduction step
110 ISO setting
115 demosaicking step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 photography mode settings
180 digital image file
185 camera settings
300 low-resolution image
302 bicubic interpolation block
304 high-resolution image
306 super-resolution sharpening block
308 super-resolution image
400 convert to YCC block
402 YCC image
404 sharpen luminance block

### PARTS LIST CONT'D

406 sharpened YCC image
   408 convert to RGB block
500 compute high-pass and low-pass images block
502 high-pass image
   504 low-pass image
506 sharpen high-pass image block
508 combine high-pass and low-pass images block
510 sharpened high-pass image
600 global sharpening block
602 global sharpened image
604 adaptive sharpening block
700 sharpen edge pixels block
702 sharpened edge pixels
704 compute first contrast block
706 compute second contrast block
708 first contrast
710 second contrast
712 adjust sharpness gain block
800 compute edge parameters block
802 local edge parameters
804 scale edge pixels block
900 compute contrast ratio block
902 contrast ratio
904 contrast ratio test block
906 no sharpening change block
908 modify sharpness gain block
1100 low-resolution image

### PARTS LIST CONT'D

1102 super-resolution sharpening block
1104 sharpened low-resolution image
1106 bicubic interpolation block
1108 high-resolution image
1110 super-resolution sharpening block
1112 super-resolution image
1200 low-resolution image
1202 pyramid decomposition block
1204 pyramid image components
1206 super-resolution sharpening block
1208 sharpened pyramid image components
1210 pyramid reconstruction block
1212 sharpened low-resolution image
1300 bicubic interpolation block
1302 high-resolution image
1304 super-resolution sharpening block
1306 super-resolution image

1. A method of providing a super-resolution image, comprising using a processor to perform the following:
(a) acquiring a captured low-resolution image of a scene;
(b) resizing the low-resolution image to provide a high-resolution image;
(c) computing local edge parameters including local edge orientations and local edge centers of gravity from the high-resolution image;
(d) selecting edge pixels in the high-resolution image responsive to the local edge parameters; and
(e) modifying the high-resolution image in response to the selected edge pixels to provide a super-resolution image.

2. The method of claim 1 wherein step (b) further includes increasing the resolution of the image using bicubic interpolation.

3. The method of claim 1 wherein step (b) further includes increasing the resolution of the image using bilinear interpolation.

4. The method of claim 1 wherein step (d) further includes selecting edge pixels in either horizontal, vertical, or diagonal directions.

5. The method of claim 1 wherein step (e) further includes converting the high-resolution image from red-green-blue (RGB) color space to luminance-chrominance (YCC) color space, modifying the luminance channel, and converting the modified high-resolution image back into RGB color space.

6. The method of claim 1 wherein step (e) further includes providing a low-pass image and a high-pass image from the high-resolution image, modifying the high-pass image, and combining the low-pass image and the modified high-pass image to produce the super-resolution image.

7. The method of claim 6 further including providing a low-pass image and a high-pass image from the high-resolution image using pyramid decomposition.

8. The method of claim 6 further including providing a low-pass image and a high-pass image from the high-resolution image using convolution.

9. The method of claim 1 wherein step (e) further includes modifying the high-resolution image with global sharpening or with adaptive sharpening.

10. The method of claim 1 wherein step (e) further includes modifying the high-resolution image with global deblurring or with adaptive deblurring.

11. The method of claim 1 wherein step (e) further includes modifying the high-resolution image by scaling the selected edge pixels by a gain factor.

12. The method of claim 1 wherein step (e) further includes computing a first contrast before modifying the high-resolution image, a second contrast after modifying the high-resolution image, and modifying the high-resolution image responsive to the first contrast and the second contrast.

13. The method of claim 1 wherein step (e) further includes modifying the high-resolution image by scaling the selected edge pixels responsive to the local edge parameters.

14. A method of providing a super-resolution image, comprising using a processor to perform the following:
(a) acquiring a captured low-resolution image of a scene;
(b) modifying the low-resolution image to provide a sharpened low-resolution image;
(c) resizing the sharpened low-resolution image to provide a high-resolution image;
(d) computing local edge parameters including local edge orientations and local edge centers of gravity from the high-resolution image;
(e) selecting edge pixels in the high-resolution image responsive to the local edge parameters; and
(f) modifying the high-resolution image in response to the selected edge pixels to provide a super-resolution image.

15. A method of providing a super-resolution image, comprising using a processor to perform the following:
(a) acquiring a captured low-resolution image of a scene;
(b) decomposing the low-resolution image into pyramid image components;
(c) modifying the pyramid image components to provide sharpened pyramid image components;
(d) reconstructing a sharpened low-resolution image from the sharpened pyramid image components;
(e) resizing the sharpened low-resolution image to provide a high-resolution image;
(f) computing local edge parameters including local edge orientations and local edge centers of gravity from the high-resolution image;
(g) selecting edge pixels in the high-resolution image responsive to the local edge parameters; and
(h) modifying the high-resolution image in response to the selected edge pixels to provide a super-resolution image.
